(19) United States
(12) Patent Application Publication
(10) Pub. No.: US 2012/0239347 A1
(43) Pub. Date: Sep. 20, 2012

(54) FAILURE DIAGNOSIS SUPPORT TECHNIQUE

(75) Inventor: Izumi NITTA, Kawasaki (JP)

(73) Assignee: FUJITSU LIMITED, Kawasaki-shi (JP)

(21) Appl. No.: 13/416,370

(22) Filed: Mar. 9, 2012

(30) Foreign Application Priority Data
Mar. 18, 2011 (JP) 2011-061647

(51) Int. Cl. G06F 17/18

(52) U.S. Cl. 702/181

(57) ABSTRACT

The disclosed method includes: calculating a first expected value of the number of failures for each combination of a feature that is a failure factor and a first group regarding classification elements of first semiconductor devices for which a failure is analyzed and second semiconductors on which a same circuit as the first semiconductors is implemented, from first data for each first group and a predetermined expression, wherein the first data includes the number of actual failures occurred in the first group and first feature values of features; and calculating, for each feature, a first indicator value representing similarity between a distribution of the first expected values over the first groups and a distribution of the numbers of actual failures over the first groups, from the first expected value for each combination of the feature and the first group and the number of actual failures for each first group.

### CROSS-REFERENCE TO RELATED APPLICATIONS

This application is based upon and claims the benefit of priority of the prior Japanese Patent Application No. 2011-061647, filed on Mar. 18, 2011, the entire contents of which are incorporated herein by reference.

### FIELD

This technique relates to a technique for supporting failure diagnosis of a semiconductor device.

### BACKGROUND

The semiconductor device such as Large Scale Integrated (LSI) circuits is tested at the shipping after the design and manufacturing. When any failure is detected at the shipping test and in the market, a failure analysis using a logical simulation or failure dictionary is carried out to extract failure candidates. Based on the failure candidates, failure factors are narrowed by the volume diagnosis in which the statistical analysis is carried out. Then, a failure candidate associated with the narrowed failure factors is selected to determine whether or not the selected failure candidate actually corresponds to a failure on the semiconductor device by a physical analysis using the electron microscope or the like, and a failure cause is identified. The failure cause is feedback to the design of the semiconductor device and/or manufacturing procedure, and any change is provided to decrease the number of failures detected at the shipping test and the like.

The failure diagnosis is a technique to presume a failure location inside of the semiconductor device for which a failure is detected by the shipping test or the like after the manufacturing. Recently, a method is proposed to further narrow the failure factors and/or to presume the failure location by using statistical analysis in the volume diagnosis.

On the other hand, the cost of the physical analysis increases along with sophisticating the manufacturing processes and enlarging the scale of the circuit. In order to decrease the cost of the physical analysis, and early identify the failure cause, it is preferable that the failure candidates to be analysis by the physical analysis are appropriately narrowed in the volume diagnosis.

Conventionally, a method of the volume diagnosis is proposed, where the statistical analysis is carried out based on failure reports of the semiconductor device, which are inputted from the failure analysis tool to output a feature that is a failure factor according to contribution degrees to the failure. The failure report includes information concerning nets or input/output pins as the failure candidates, and may further include a type of failure, such as open failure or bridge failure. Typically, in the method of the volume diagnosis, a list of the features as the candidates of the failure factors is inputted or embodied in a diagnosis apparatus in advance. Here, the features that are the failure factors include layout information such as wiring length, the number of via holes, and wiring density, wiring pattern, which is a factor of the open failure or bridge failure, and the like. This proposed method of the volume diagnosis pays attention to one certain type of feature, and uniformly classifies the circuit information such as netlists to plural groups from the top by sorting in descending order of the feature value of the feature to which the attention is paid. For each group, an expected value of the number of failures and measured value of the number of failures are respectively calculated. The expected value is calculated using a model expression based on the feature value of the feature to which the attention is paid, and the measured value is calculated by counting the failure candidates included in each group from the failure list. In addition, the contribution degree (or importance degree) of the one certain type of feature, to which the attention is paid, to the failure is calculated based on the similarity of the distributions of the expected value and measured value. By repeating the aforementioned processing for all types of features to calculate the contribution degrees of the respective types of features to the failure, the feature of the type whose contribution degree is high is identified as the failure factor.

However, when there is not sufficient amount of failure data with respect to the number of features, there is a problem that the validity of the aforementioned method is deteriorated. There is no effective countermeasure for such a problem in the aforementioned technique.

### SUMMARY

A method relating to this technique includes: (A) calculating a first expected value of the number of failures for each combination of a feature of a plurality of features that are failure factors and a first group of a plurality of first groups regarding classification elements of first semiconductor devices for which a failure is analyzed and second semiconductors on which a same circuit as the first semiconductors is implemented, from first data for each of the plurality of first groups and a predetermined expression, wherein the first data includes the number of actual failures occurred in the first group and first feature values of the plurality of features; and (B) calculating, for each of the plurality of features, a first indicator value representing similarity between a distribution of the first expected values over the plurality of first groups and a distribution of the numbers of actual failures over the plurality of first groups, from the first expected value for each combination of the feature and the first group and the number of actual failures for each of the plurality of first groups.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a functional block diagram of a failure diagnosis support apparatus relating to an embodiment;

FIG. 2 is a diagram depicting an example of a failure report relating to a semiconductor device to be considered;

FIG. 3 is a diagram depicting an example of a past failure report;

FIG. 4 is a diagram to explain the failure report;

FIG. 5 is a diagram depicting an example of a failure factor list;

FIG. 6 is a diagram depicting a main processing flow relating to the embodiment;

FIG. 7 is a diagram depicting a processing flow of a learning data preparation processing;

FIG. 8 is a diagram depicting an example of a processing flow of a learning data generation processing;

FIG. 9 is a diagram depicting an example of a processing flow of the learning data generation processing;

FIG. 10 is a diagram to explain the learning data generation processing;

FIG. 11 is a diagram to explain the learning data generation processing;

FIG. 12 is a diagram depicting an example of learning data for the failure report data to be considered;

FIG. 13 is a diagram depicting an example of the learning data for the common circuit;

FIG. 14 is a diagram depicting an example of a processing flow of a learning data generation processing;

FIG. 15A is a diagram to explain the learning data generation processing;

FIG. 15B is a diagram to explain the learning data generation processing;

FIG. 15C is a diagram to explain the learning data generation processing;

FIG. 16 is a diagram to explain the learning data generation processing;

FIG. 17 is a diagram depicting an example of the learning data for the common process;

FIG. 18 is a diagram depicting a relationship between the failure report data;

FIG. 19 is a diagram depicting a processing flow of a usefulness degree calculation processing;

FIG. 20 is a diagram depicting a processing flow of the usefulness degree processing;

FIG. 21 is a diagram depicting an example of data stored in a second data storage unit;

FIG. 22A is a diagram depicting an example of distributions of the number of actual failures and the expected value of the number of failures;

FIG. 22B is a diagram depicting an example of distributions of the number of actual failures and the expected value of the number of failures;

FIG. 23 is a diagram depicting an example of data stored in a third data storage unit;

FIG. 24 is a diagram depicting a processing flow of a processing for generating a failure occurrence probability prediction expression;

FIG. 25 is a diagram depicting an example of data stored in a fourth data storage unit;

FIG. 26 is a diagram depicting an example of data stored in the fourth data storage unit;

FIG. 27 is a diagram depicting a processing flow of an importance degree ranking generation processing;

FIG. 28 is a diagram depicting an example of data stored in a fifth data storage unit;

FIG. 29 is a diagram depicting the processing flow of the importance degree ranking generation processing;

FIG. 30 is a diagram depicting an example of data stored in the fifth data storage unit;

FIG. 31 is a diagram depicting an example of output data; and

FIG. 32 is a functional block diagram of a computer.

### DESCRIPTION OF EMBODIMENTS

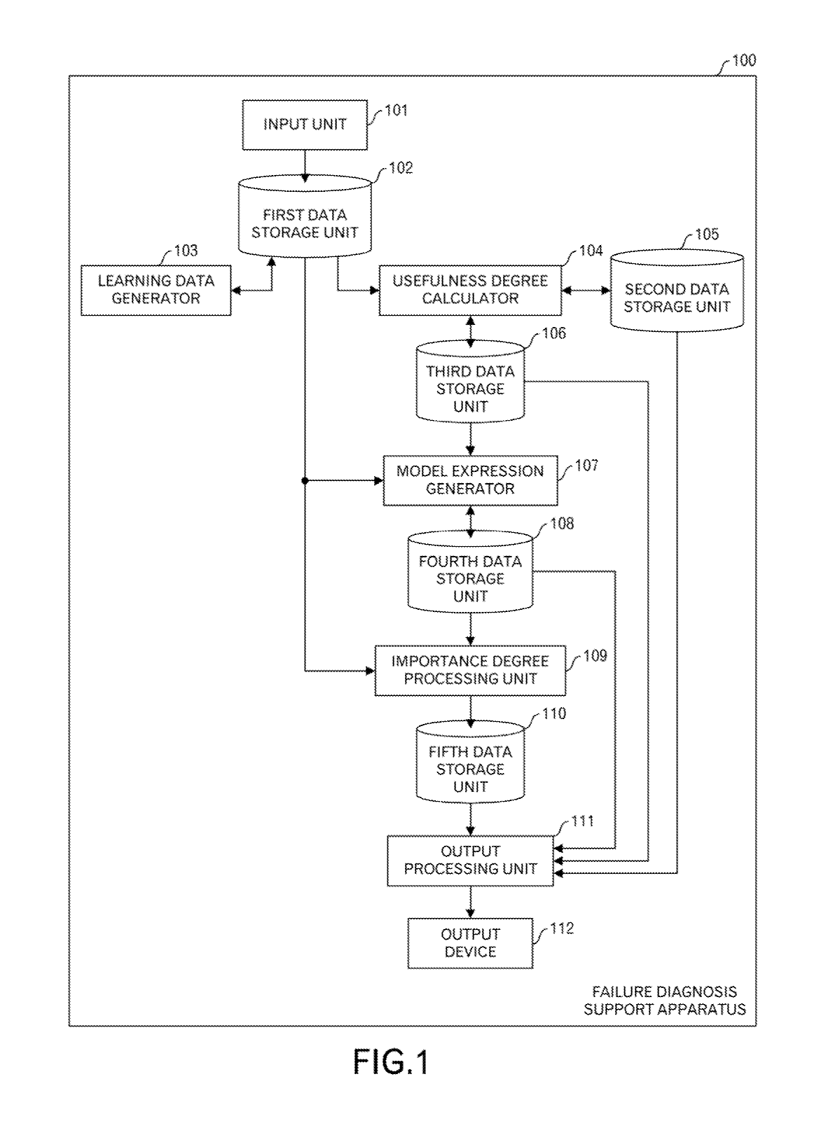

FIG. 1 illustrates a functional block diagram of a failure diagnosis support apparatus 100 relating to an embodiment of this technique. This failure diagnosis support apparatus 100 has an input unit 101, a first data storage unit 102, a learning data generator 103, a usefulness degree calculator 104, a second data storage unit 105, a third data storage unit 106, a model expression generator 107, a fourth data storage unit 108, an importance degree processing unit 109, a fifth data storage unit 110, an output processing unit 111 and an output device 112.

The input unit 101 stores data inputted from a user or the like into the first data storage unit 102. Incidentally, instructions from the user or the like may be outputted from the input unit 101 to other processing units. In addition, the learning data generator 103 generates learning data from data stored in the first data storage unit 102, and stored in the first data storage unit 102. The usefulness degree calculator 104 carries out a processing using data stored in the first data storage unit 102, and stores the processing results into the third data storage unit 106. Incidentally, the usefulness degree calculator 104 stores the data during the processing into the second data storage unit 105. The model expression generator 107 carries out a processing by using data stored in the third data storage unit 106 and the first data storage unit 102, into the fourth data storage unit 108. The importance degree processing unit 109 carries out a processing using data stored in the fourth data storage unit 108 and the first data storage unit 102, into the fifth data storage unit 110. In response to instructions, for example, from the user, the output processing unit 111 outputs data stored in the second data storage unit 105, third data storage unit 106, fourth data storage unit 108 and fifth data storage unit 110, to the output device 112.

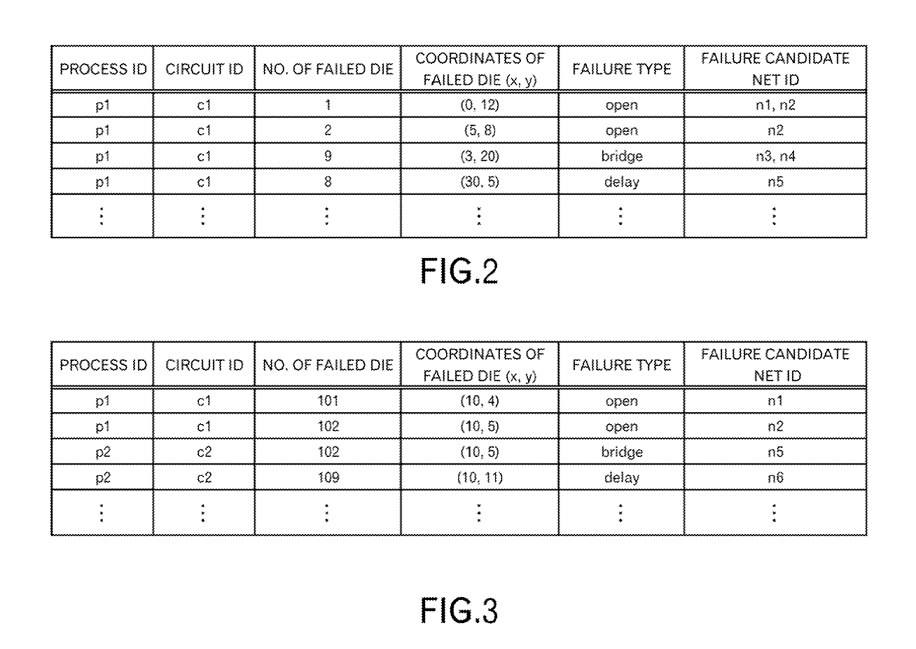

Next, an example of data that is stored in the first data storage unit 102 through the input unit 101 by inputs from the user will be illustrated in FIGS. 2 to 5. The first data storage unit 102 stores data of failure reports for a semiconductor device to be considered or analyzed as illustrated in FIG. 2, for example. The failure report for the semiconductor device to be considered is data outputted as an analysis result of the volume failure diagnosis, which was described in the background, for example. In an example of FIG. 2, a process ID (identifier) of a process of the failure diagnosis target (i.e. process technology such as 40 nm or 90 nm), a circuit ID (identifier), a number of failed die, coordinates of the failed die on a wafer, a failure type and a failure candidate net ID (identifier) are registered. There is a case where plural failure candidate nets identified on one die. However, the number of failed dies (=the number of actual failures) can be counted for each net ID from this data. Similarly, it is possible to count the number of failed dies (=the number of actual failures) for each area set on the wafer. In this embodiment, it is presumed that there is only a little amount of the failure reports for the semiconductor device to be examined.

Furthermore, past failure reports are also stored in the first data storage unit 102. As illustrated in FIG. 3, the data format is similar to that illustrated in FIG. 2.

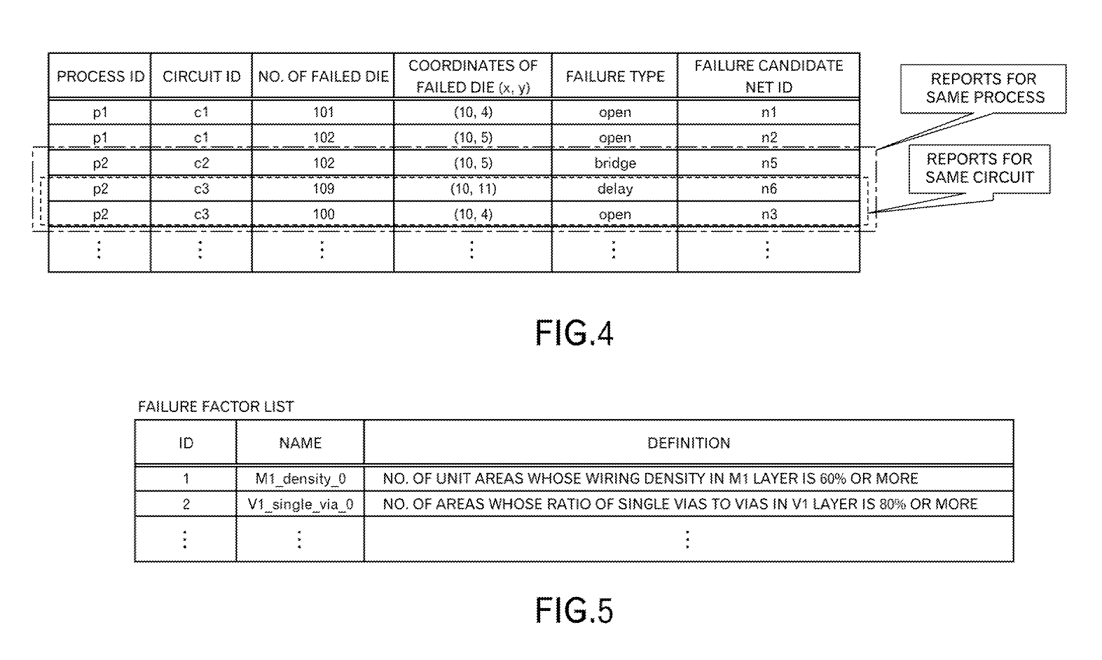

Furthermore, in this embodiment, as illustrated in FIG. 4, the process ID and circuit ID have been attached to each record of the past failure report. Thus, it is possible to identify a failure die whose circuit is the same and identify a failure die whose process is the same.

Moreover, FIG. 5 illustrates an example of a failure factor list stored in the first data storage unit 102. In an example of FIG. 5, an identifier of a feature that is a failure factor, a name and definition are registered. As illustrated in FIG. 5, as the feature that is a failure factor, a factor that can be represented as a design rule, is defined.

Furthermore, data of the netlist, layout data, displacement data of the die on wafer and other data are stored in the first data storage unit 102.

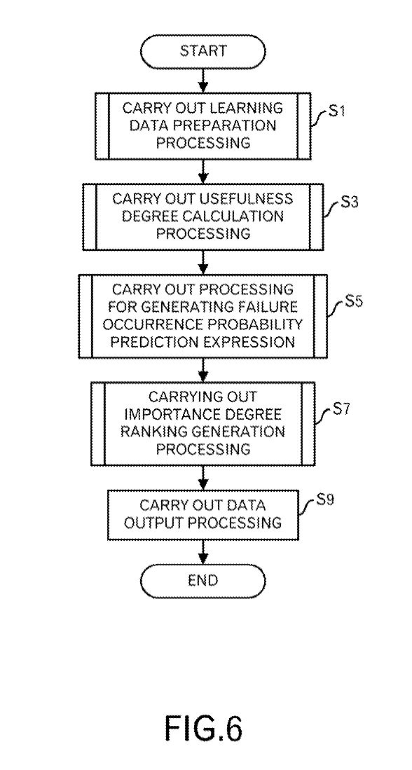

Next, processing contents of the failure diagnosis support apparatus 100 will be explained by using FIGS. 6 to 31.

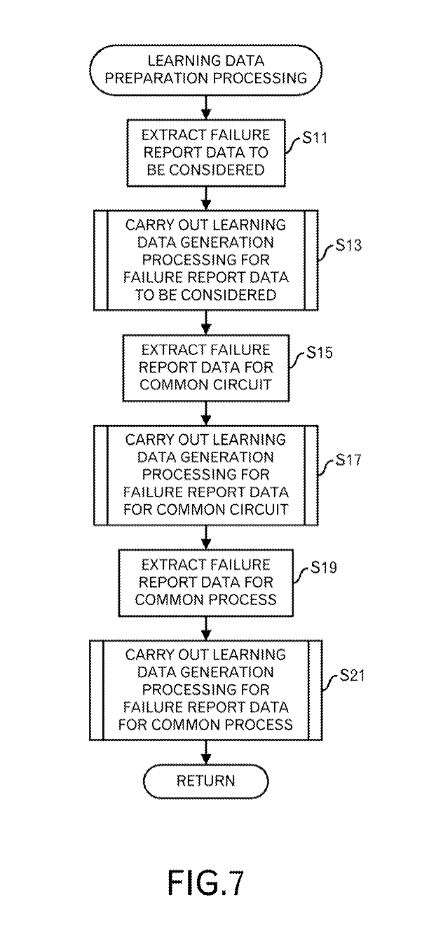

First, the learning data generator 103 of the failure diagnosis support apparatus 100 carries out a learning data preparation processing (FIG. 6: step S1). This learning data preparation processing will be explained by using FIGS. 7 to 18.

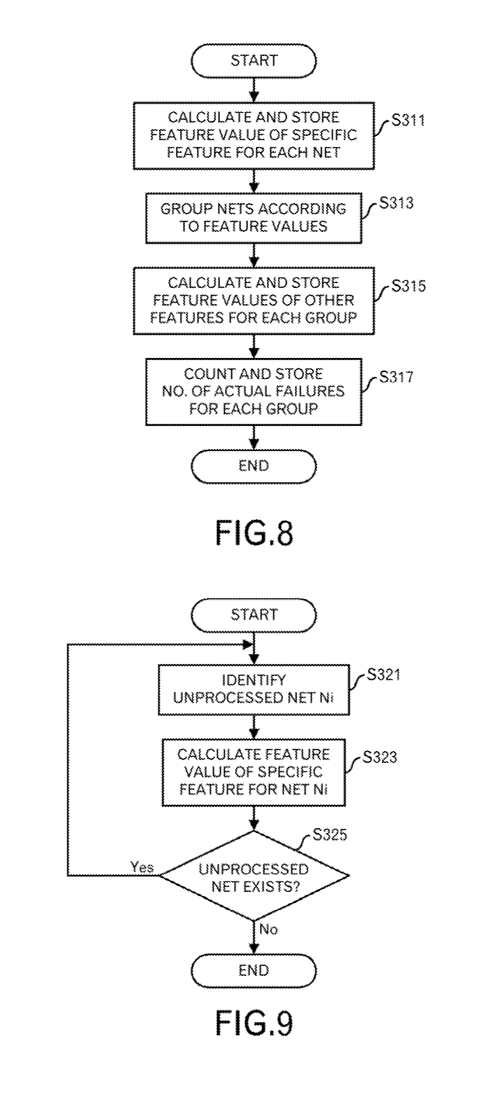

The learning data generator 103 extracts failure report data to be considered among failure report data stored in the first data storage unit 102 (FIG. 7: step S11). Then, the learning data generator 103 carries out a learning data generation processing for the failure report data to be considered (step S13). This processing will be explained by using FIGS. 8 to 18.

FIG. 8 illustrates an example of the learning data generation processing. The learning data generator 103 calculates, for a specific feature defined in the failure factor list, a feature value for each net, for example, from the layout data stored in the first data storage unit 102, and stores the calculated value into the first data storage unit 102 (FIG. 8: step S311).

The processing of the step S311 is a processing as illustrated in FIG. 9, for example. First, the learning data generator 103 identifies an unprocessed net Ni in the netlist data (step S321). Then, the learning data generator 103 calculates, for the net Ni, a feature value for the specific feature by using the layout data and the like, and stores the calculated value, for example, into the first data storage unit 102 (step S323). After that, the learning data generator 103 determines whether or not there is an unprocessed net (step S325), and when there is an unprocessed net, the processing returns to the step S321, and when there is no unprocessed net, the processing ends.

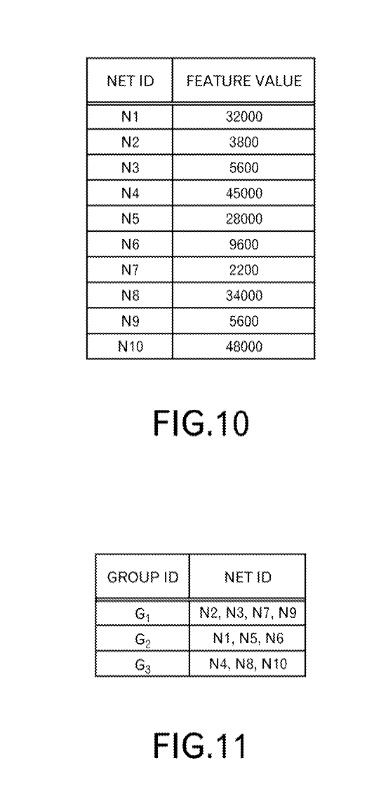

For example, when the specific feature is the number of unit areas whose wiring density in M1 layer is 60% or more, the number of unit areas whose wiring density is 60% or more is counted at the step S323 among unit areas through which the wiring of the net Ni passing through the M1 layer passes. Then, for example, data as illustrated in FIG. 10 is stored, for example, in the first data storage unit 102. In an example of FIG. 10, in case where there are 10 nets, a calculated feature value of the specific feature is registered, respectively.

Returning to the explanation of the processing of FIG. 8, the learning data generator 103 groups the respective nets in the netlist according to the feature values calculated at the step S311 (step S313). Although various methods for grouping exist, as one method, the nets are grouped in ascending order of the feature values to group the nets into the predetermined number of groups in this order. In an example of FIG. 10, the nets are arranged in order of N7, N2, N3, N9, N5, N6, N1, N8, N4 and N10. Therefore, as illustrated in FIG. 11, group G₁ includes N7, N2, N3 and N9, group G₂ includes N5, N6 and N1, and group G₃ includes N8, N4 and N10. Furthermore, a similar processing may be carried out for another feature, and a result of grouping in another viewpoint may also be adopted.

Furthermore, the learning data generator 103 calculates feature values for the other features for each group, and stores the calculated values into the first data storage unit 102 (step S315). For each feature other than the specific feature among the features that are failure factors and registered in the failure factor list, the feature value is calculated in group. For example, in case of the feature that is the number of unit areas whose ratio of the single vias among the vias in V1 layer is 80% or more, the number of unit areas whose ratio of the single vias among the unit areas through which the wirings of the net Ni passing through the layer V1 pass through is counted from the layout data, and the counted numbers are totaled for each group.

Then, the learning data generator 103 counts the number of actual failures for each group from the failure reports to be processed, and stores the counted number into the first data storage unit 102 (step S317). For example, by counting the number of occurrences for each net ID and totaling the number of occurrences for each group, the number of actual failures is calculated.

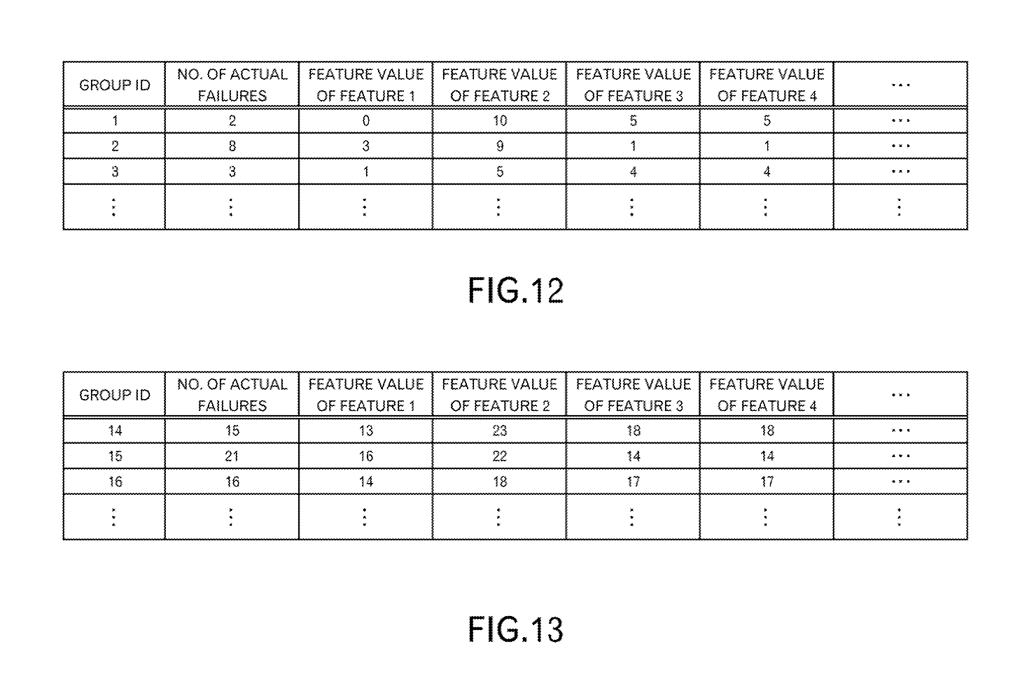

By carrying out such a processing, data as illustrated in FIG. 12 is stored in the first data storage unit 102, as the learning data, for example. In an example of FIG. 12, for each group, a group ID, the number of actual failures, feature value of feature 1, feature value of feature 2, feature value of feature 3, feature value of feature 4 . . . are stored. The number of features depends on the failure factor list.

Returning to the explanation of the processing of FIG. 7, next, the learning data generator 103 extracts, from the first data storage unit 102, failure report data to be considered and failure report data for failed dies in which the same circuit as the circuit implemented on the failed die included in the failure report data to be considered are implemented, as failure report data for the common circuit (step S15). For example, from the circuit IDs included in the failure report data to be considered as illustrated in FIG. 2, the numbers of the failed dies having the same circuit ID as the circuit ID in FIG. 2 are extracted. Based on the extracted numbers of the failed dies, from the past failure report data illustrated in FIG. 3, the failure report data for the common circuit is extracted.

After that, the learning data generator 103 carries out a learning data generation processing for the failure report data for the common circuit (step S17). Basically, the same processing as the step S13 is carried out. As illustrated in FIG. 13, the learning data (hereinafter, called “learning data for the common circuit”) generated by this processing has the same format as that illustrated in FIG. 12.

Furthermore, the learning data generator 103 extracts, from the first data storage unit 102, the failure report data to be considered and the failure report data for the failed dies for which the same process as the process used when the failed die included in the failure report data to be considered was manufactured is used, as the failure report data for the common process (step S19). For example, based on process IDs included in the failure report data to be considered as illustrated in FIG. 2, the numbers of the failed dies having the same process ID as the process ID in FIG. 2 are extracted. The failure report data for the common process is extracted from the past failure report data as illustrated in FIG. 3 based on the extracted numbers of the failed dies.

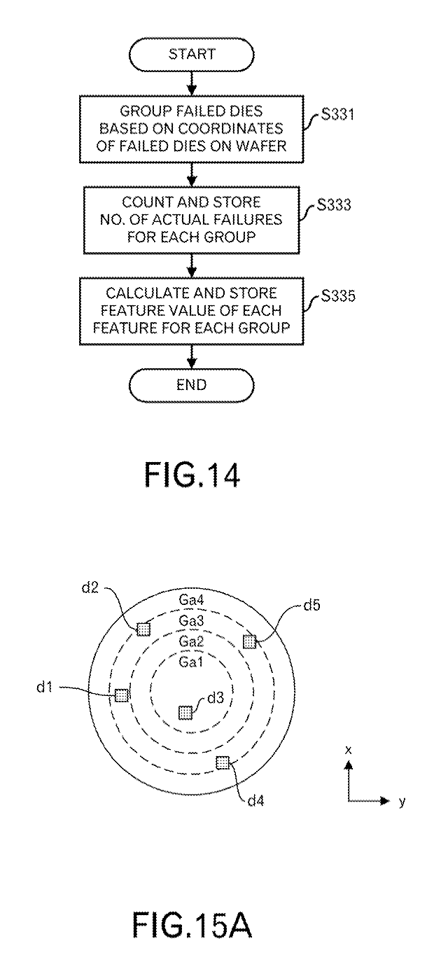

After that, the learning data generator 103 carries out a learning data generation processing for the failure report data for the common process (step S21). The failure report data for the common process includes the failure report data for different semiconductor devices. Therefore, a processing flow as illustrated in FIG. 14 is adopted, for example.

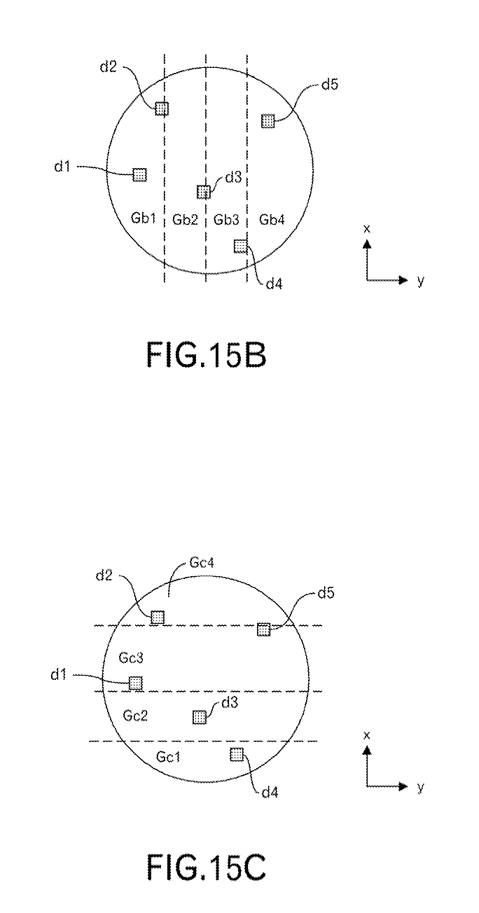

The learning data generator 103 groups the failed dies based on the coordinates of the failed dies on the wafer, which are included in the failure report data for the common process (FIG. 14: step S331). For example, as illustrated in FIG. 15A, area Ga1, Ga2, Ga3 and Ga4 may be set, for example, concentrically on the wafer (outer circle drawn by the solid line), and these areas may be handled as groups. Then, it is determined, based on the coordinates of the failed dies, to which group the failed die belongs. As for the areas, as illustrated in FIG. 15B, areas Gb1, Gb2, Gb3 and Gb4 may be set in the vertical direction, and these areas may be handled as the groups. Then, it may be determined, based on the coordinates of the failed dies, to which group the failed die belongs. Furthermore, the as illustrated in FIG. 15C, areas Gc1, Gc2, Gc3 and Gc4 may be set in a horizontal direction, and these areas may be handled as the groups. Then, it may be determined, based on the coordinates of the failed dies, to which group the failed die belongs. Any one of these methods may be adopted, and any combination of these may be adopted. Here, three kinds of areas themselves are adopted as the groups.

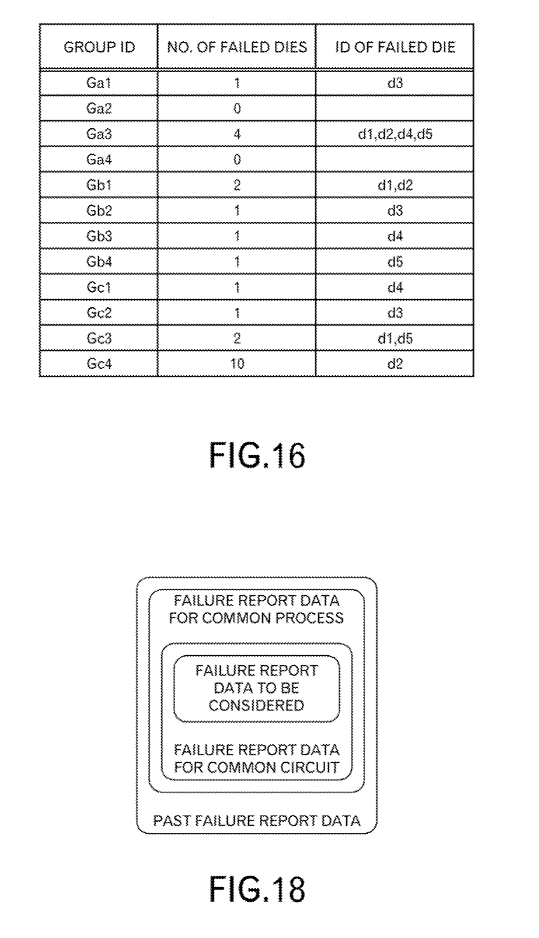

Then, for example, data as illustrated in FIG. 16 is obtained. As an example of FIG. 16, a group ID (identifier), the number of failed dies (i.e. the number of actual failures) and an ID (identifier) of the failed die are registered. Up to the step S331, the group ID and the ID of the pertinent failed die are registered.

After that, the learning data generator 103 counts the number of actual failures for each group, and stores the counted numbers into the first data storage unit 102 (step S333). In the example of FIG. 16, the number of IDs of the failed dies, which are stored in association with the group, is counted.

Then, the learning data generator 103 calculates, for each group, the feature value of each feature, and stores the feature values with the number of actual failures into the first data storage unit 102 (step S335). Because a failure candidate net ID is identified from the ID of the failed die. Therefore, the feature value of each feature is calculated as described above, and the feature values for the same group are totaled.

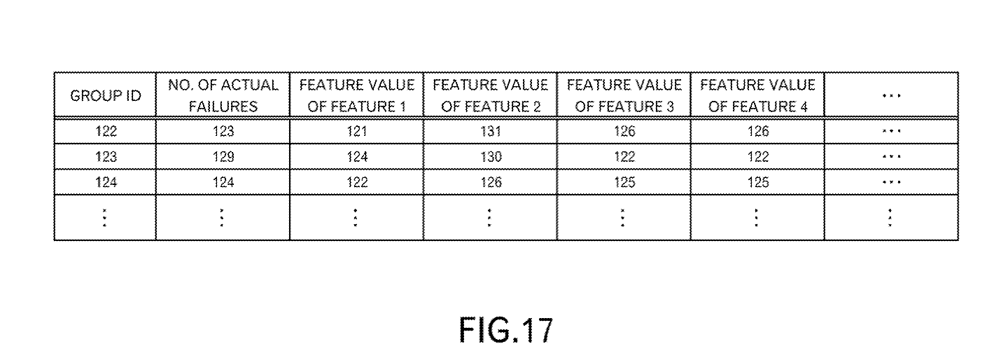

The learning data generated by such a processing (hereinafter, referred to learning data for the common process) has the same format to that illustrated in FIG. 12, as illustrated in FIG. 17.

In addition, in this embodiment, as illustrated in FIG. 18, when it is presumed that the failure report to be considered this time is included in the past failure report data, a portion of this past failure report data is the failure report data for the common process, and furthermore, a portion of this failure report data for the common process is the failure report data for the common circuit, and a portion of the failure report data for the common circuit is the failure report data to be considered.

Thus, even when there is only a little amount of the failure report data to be considered, the amount of the failure report data can be increased in view of the same circuit and the same process.

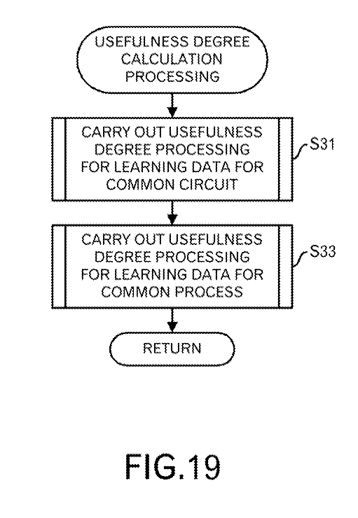

Returning to the explanation of the processing in FIG. 6, the usefulness degree calculator 104 carries out a usefulness degree calculation processing by using the learning data stored in the first data storage unit 102 (step S3). The usefulness degree calculation processing will be explained by using FIGS. 19 to 23.

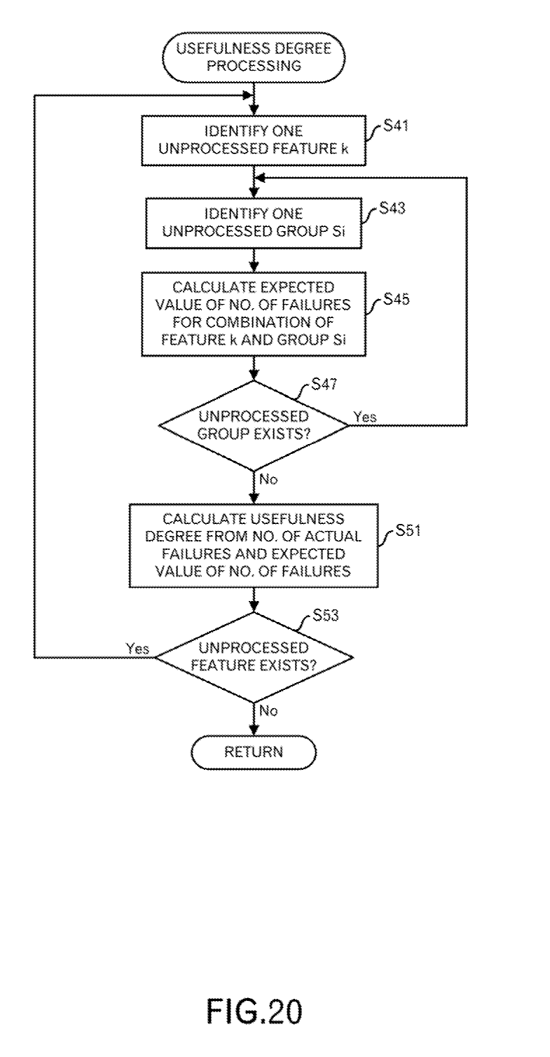

First, the usefulness degree calculator 104 carries out a usefulness degree processing for the learning data for the common circuit (FIG. 19: step S31). The details of the processing will be explained by using FIGS. 20 to 23.

In addition, the usefulness degree calculator 104 carries out the usefulness degree processing for the learning data for the common process (step S33). The processing of this step is the processing that will be explained by using FIGS. 20 to 23, although the contents of the learning data to be processed are different. Then, the processing returns to the calling-source processing.

Next, the usefulness degree processing will be explained by using FIGS. 20 to 23.

First, the usefulness degree calculator 104 identifies one unprocessed feature k in the learning data to be processed, which is stored in the first data storage unit 102 (FIG. 20: step S41). Moreover, the usefulness degree calculator 104 identifies one unprocessed group Sᵢ in the learning data relating to the processing (step S43). Then, the usefulness degree calculator 104 calculates an expected value of the number of failures E (k, Sᵢ) for a combination of the identified feature k and the identified group Sᵢ, and stores the calculated value into the third data storage unit 106 (step S45). Specifically, the expected value of the number of failures E (k, Sᵢ) is calculated according to the following expression.

$$E ( k , Si ) = \frac{{f}_{ik}}{{\sum }_{j} {f}_{jk}} \cdot ( {C}_{all} - {C}_{random} ) + \frac{{C}_{random}}{m} \qquad ( 1 )$$

One record in the learning data indicates one group, and the feature values fᵢ to f_{N} are included for each feature. Therefore, the feature value of feature k (1≦k≦N) for the group Sᵢ is represented by fᵢₖ. In addition, a dominator of a first term in the expression (1) represents a total sum of the feature values fⱼₖ of the features k for all groups j. Furthermore, Cₐₗₗ represents the total numbers of actual failures for the learning data to be processed. Moreover, C_{random} represents the number of failures, which randomly occur, and is a constant, here. In addition, m represents the number of groups.

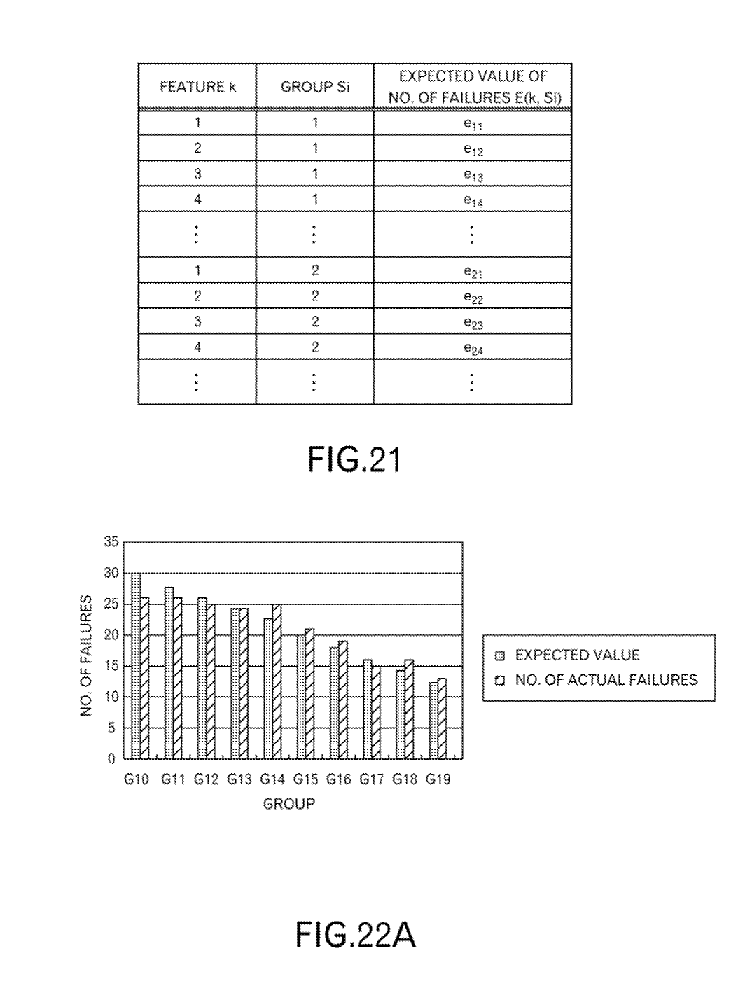

For example, data as illustrated in FIG. 21 is stored in the second data storage unit 105. In an example of FIG. 21, the expected value of the number of failures E (k, Sᵢ) is registered in association with the combination of the feature k and group Sᵢ.

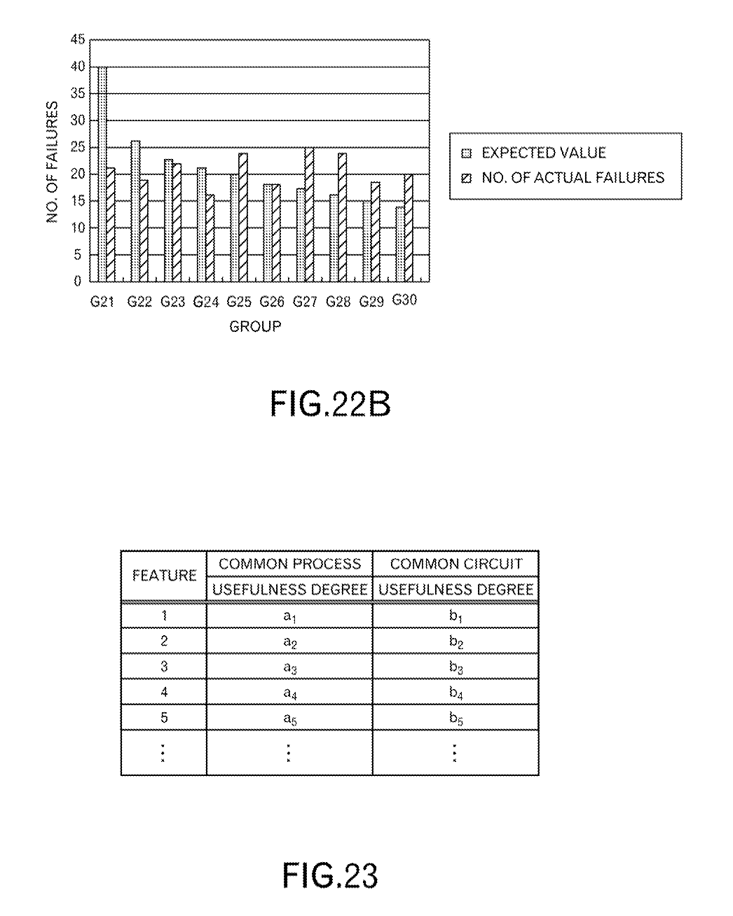

In this embodiment, paying attention to the feature, the expected value of the number of failures is calculated for each group. For example, graphs as illustrated in FIGS. 22A and 22B can be generated, though the number of actual failures is counted for each group but the number of actual failures is not obtained for each feature in the learning data. FIG. 22A illustrates a diagram to represent a distribution with respect to the numbers of failures for the feature 1, for example. Namely, a pair of the number of actual failures and the expected value of the number of failures is arranged for each group. On the other hand, FIG. 22B is a diagram to represent a distribution with respect to the number of failures for the feature 2, for example.

Then, the usefulness degree calculator 104 determines whether or not there is an unprocessed group (step S47). When there is an unprocessed group, the processing returns to the step S43. On the other hand, when there is no unprocessed group, the usefulness degree calculator 104 calculates a usefulness degree for the identified feature k by using data (FIG. 21) stored in the second data storage unit 105 and the learning data stored in the first data storage unit 102, and stores the usefulness degree into the third data storage unit 106 (step S51).

In this embodiment, paying attention to a certain feature k, a usefulness degree is introduced as one of indicators representing similarity between the distribution of the expected value of the number of failures over the groups and the distribution of the number of actual failures over the groups. For example, when comparing the case of FIG. 22A with the case of FIG. 22B, the distribution of the expected value of the number of failures and the distribution of the number of actual failures for the case of FIG. 22A for the feature 1 are much similar. Therefore, it is determined in this embodiment that the usefulness degree of the feature 1 is higher.

More specifically, the usefulness degree Aₖ is calculated for the feature k by using the following expression, for example.

$${A}_{k} {\sum }_{i} \frac{{( {t}_{i} - E ( k , Si ) )}^{2}}{E ( k , Si )} \qquad ( 2 )$$

tᵢ represents the number of actual failures for the group Sᵢ. This expression (2) represents a squared sum of relative errors between the number of actual failures and the expected value of the number of failures. However, the greater the difference between the distributions is, the greater the usefulness degree Aₖ calculated by this expression (2) is. Therefore, a reciprocal of the expression (2) may be used as the usefulness degree for example.

After that, the usefulness degree calculator 104 determines whether or not there is an unprocessed feature in the learning data to be processed (step S53). When there is an unprocessed feature, the processing returns to the step S41. On the other hand, when there is no unprocessed feature, the processing returns to the calling-source processing.

By carrying out the aforementioned processing, data as illustrated in FIG. 23 is obtained. In an example of FIG. 23, the usefulness degree for the learning data for the common process and the usefulness degree for the learning data for the common circuit is stored.

Although such usefulness degrees are also used for the processing described below, and may be used as a modification indicator of the design or manufacture.

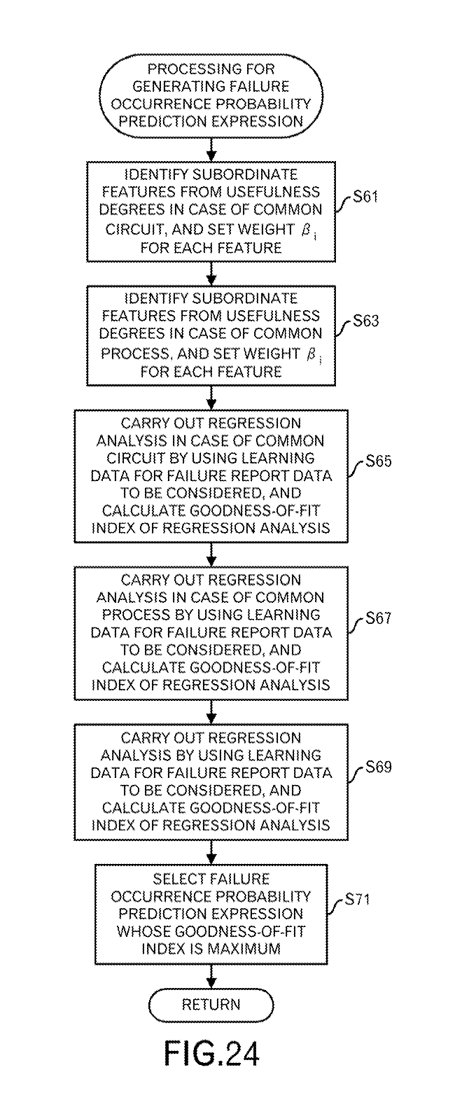

Returning to the explanation of the processing of FIG. 6, next, the model expression generator 107 carries out a processing for generating a failure occurrence probability prediction expression (step S5). This processing will be explained by using FIGS. 24 to 26.

First, the model expression generator 107 identifies subordinate features based on the usefulness degree in case of the common circuit, which is stored in the third data storage unit 106, and sets weight βᵢ for each feature i (FIG. 24: step S61). For example, the features are sorted in ascending order of the usefulness degree, and for example, the features included in the subordinate 20% are identified as the subordinate features, for example. In addition, the features whose usefulness degree (in case of reciprocal of the value of the expression (2)) is equal to or less than 10% of the maximum value of the usefulness degree may be identified as the subordinate features. Furthermore, in case of the common circuit, βᵢ=t (t is a value that is much less than 1) is set for the subordinate features, and βᵢ=1 is set for the other features. This is because it is considered that the similarity of the case of the common circuit with the semiconductors included in the failure reports to be considered is more than that of the common process.

Moreover, the model expression generator 107 identifies the subordinate features based on the usefulness degree in case of the common process, which is stored in the third data storage unit 106, and sets weights βᵢ for each feature i (step S63). A method for identifying the subordinate features is the same as that at the step S61. However, as for the weight βᵢ, βᵢ=0 is set for the subordinate features. βᵢ=1 is set for the other features.

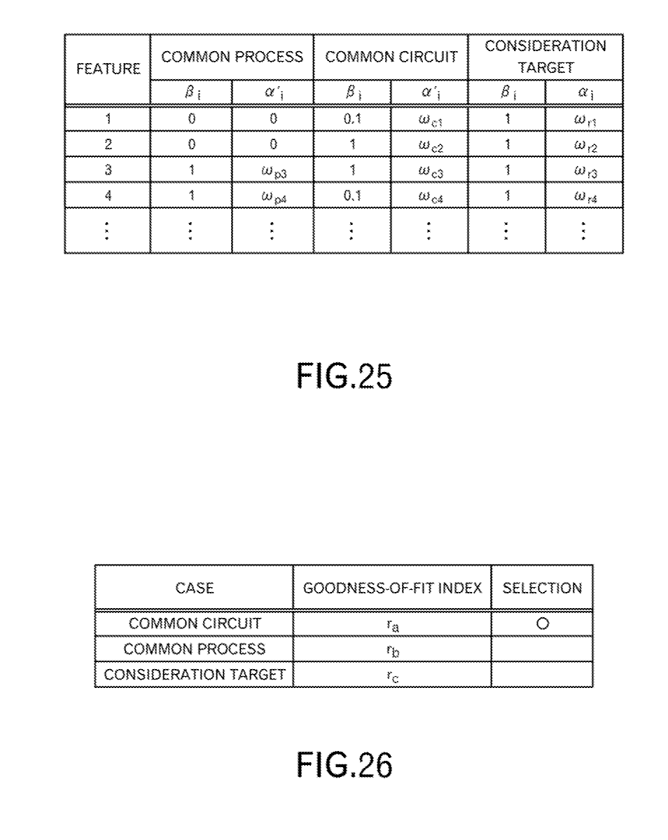

For example, data as illustrated in FIG. 25 is obtained as data under the processing, and is stored in the fourth data storage unit 108. In an example of FIG. 25, for each feature, a weight βᵢ in case of the common process and a coefficient αᵢ′ calculated below, a weight βᵢ in case of the common circuit and a coefficient αᵢ′ calculated below, a weight βᵢ in case of the learning data to be considered and a coefficient αᵢ calculated below are stored. Incidentally, the weights βᵢ in case of the common circuit and in case of the common process are set as described above. However, “1” is set to all of the weights βᵢ for the learning data to be considered. The coefficients αᵢ′ are calculated by the following regression analysis.

Next, the model expression generator 107 carries out the regression analysis in case of the common circuit by using the learning data for the failure report data to be considered, which is stored in the first data storage unit 102, to calculate a goodness-of-fit index ra of the regression analysis, and stores the results of the regression analysis and the goodness-of-fit index of the regression analysis into the fourth data storage unit 108 (step S65).

In this embodiment, as indicated in the following expression (3), the failure occurrence probability p is represented by a total sum of products of the feature value fᵢ and coefficient αᵢ of each feature i. However, as described above, because each feature i is weighted, the coefficient αᵢ is represented by a product of αᵢ′ and weight αᵢ, and the coefficient αᵢ′ is calculated here. As for βᵢ, data in the column of the common circuit in the data illustrated in FIG. 25 is used.

$$p = {\sum }_{i = 1}^{N} {α}_{i} \cdot {f}_{i} = {\sum }_{i = 1}^{N} {α}_{i}^{′} \cdot {β}_{i} \cdot {f}_{i} \qquad ( 3 )$$

The regression analysis itself is a well-known method. Therefore, further explanation is omitted. Furthermore, as the goodness-of-fit index, a coefficient of determination is used, for example. The coefficient of determination is represented as follows:

$${R}^{2} = 1 - \frac{{\sum }_{i} {( {t}_{i} - {p}_{i} )}^{2}}{{\sum }_{i} {( {t}_{i} - {t}_{a} )}^{2}} \qquad ( 4 )$$

Here, tᵢ is a failure occurrence ratio based on the number of actual failures in the learning data, tₐ is an average value of the failure occurrence ratios based on the number of actual failures, and pᵢ represents a calculation value of the failure occurrence probability by the regression expression. The coefficient of determination is well-known, and further explanation is omitted.

Moreover, because the number of actual failures is registered in the learning data, the actual failure occurrence probability p for each group is obtained by dividing the number of actual failures by the total sum N of the numbers of actual failures in the learning data.

Furthermore, the regression analysis is carried out by using the learning data for the failure report data to be considered in order to avoid a situation that a unique tendency to the past failure report data becomes noises when generating the failure occurrence probability prediction expression.

Moreover, the model expression generator 107 carries out the regression analysis in case of the common process by using the learning data for the failure report data to be considered, which is stored in the first data storage unit 102, to calculate a goodness-of-fit index rb of the regression analysis, and stores the result of the regression analysis and the goodness-of-fit index of the regression analysis into the fourth data storage unit 108 (step S67). The contents of the calculation itself are the same as those at the step S65. As for βᵢ, data in the column of the common process in the data illustrated in FIG. 25 is used.

Furthermore, the model expression generator 107 carries out the regression analysis for consideration target by using the learning data for the failure report data to be considered, which is stored in the first data storage unit 102, to calculate the goodness-of-fit index rc of the regression analysis, and stores the result of the regression analysis and the goodness-of-fit index of the regression analysis into the fourth data storage unit 108 (step S69). The contents of the calculation itself are the same as those at the step S65. However, at this step, βᵢ=1. Therefore, αᵢ′=αᵢ.

In this embodiment, the regression analysis for the consideration target is carried out in order to void the overlook of the true failure factor in the failure report data. Namely, this is carried out to reconsider the feature for which the little weight is set or which is not considered in the failure occurrence probability prediction expression in case of the common circuit and in case of the common process.

When the processing up to this stage is carried out, data is embed into a table as illustrated in FIG. 25. In addition, as illustrated in FIG. 26, data of the goodness-of-fit index becomes complete.

Then, the model expression generator 107 selects a failure occurrence probability prediction expression whose goodness-of-fit index is the maximum among the goodness-of-fit indexes ra, rb and rc (step S71). The most suitable failure occurrence probability prediction expression is selected. For example, as illustrated in FIG. 26, the selection flag of the selected expression is set.

By carrying out such a processing, it becomes possible to generate the failure occurrence probability prediction expressions for three cases, and to select a failure occurrence probability prediction expression that is most suitable for the learning data by the failure report data to be considered.

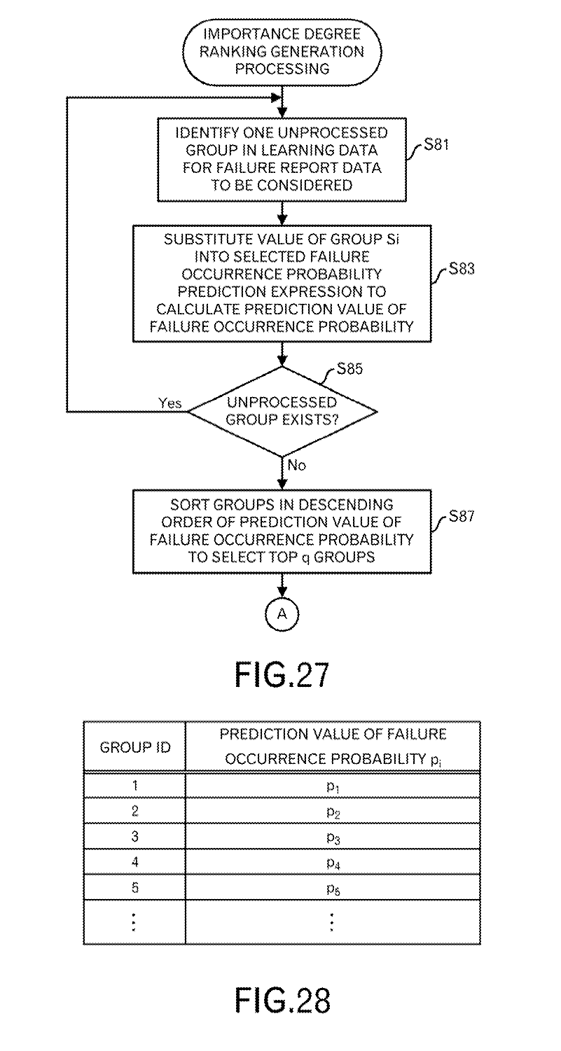

Returning to the explanation of the processing of FIG. 6, the importance degree processing unit 109 carries out an importance degree ranking generation processing (step S7). This importance degree ranking generation processing will be explained by using FIGS. 27 to 30.

The importance degree processing unit 109 identifies an unprocessed group Sᵢ in the learning data by the failure report data to be considered, which is stored in the first data storage unit 102 (FIG. 27: step S81). Then, the importance degree processing unit 109 substitutes the feature values of the respective features in the identified group Sᵢ into the selected failure occurrence probability expression (expression (3)) to calculate a prediction value of the failure occurrence probability, and stores the calculated value into the fifth data storage unit 110 (step S83). For example, data as illustrated in FIG. 28 is stored in the fifth data storage unit 110. In an example of FIG. 28, for each group, the calculated prediction value pᵢ of the failure occurrence probability is stored.

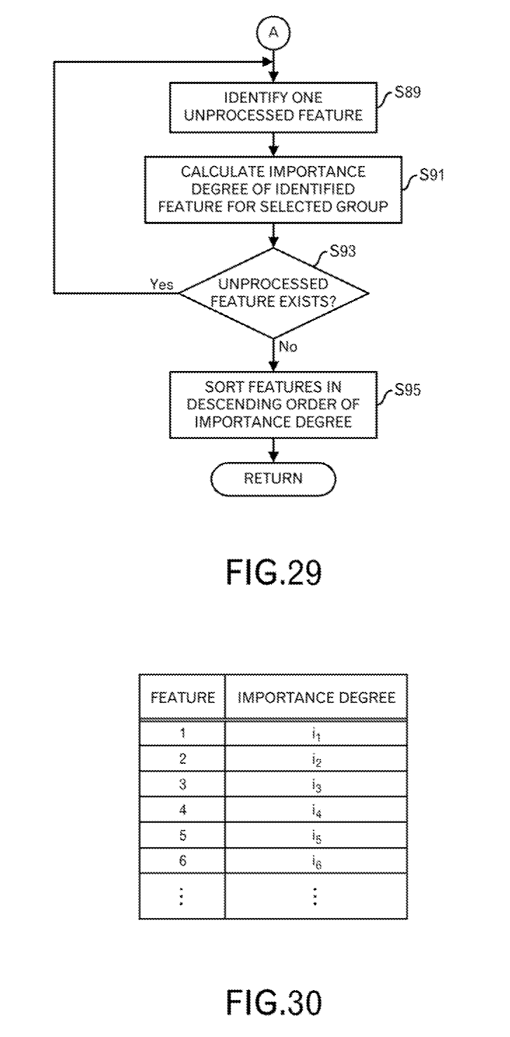

Then, the importance degree processing unit 109 determines whether or not there is an unprocessed group (step S85). When there is an unprocessed group, the processing returns to the step S81. On the other hand, when there is no unprocessed group, the importance degree processing unit 109 sorts the groups in descending order of the prediction value of the failure occurrence probability, and selects the top q groups (q is a predetermined integer) (step S87). Hence, groups that have large contribution to the failure can be extracted. Then, the processing shifts to a processing of FIG. 29 through terminal A.

Shifting to the explanation of the processing of FIG. 29, the importance degree processing unit 109 identifies one unprocessed feature in the learning data for the failure report data to be considered, which is stored in the first data storage unit 102 (step S89). Then, the importance degree processing unit 109 calculates an importance degree for the identified feature for the groups selected at the step S87, and stored the calculated values into the fifth data storage unit 110 (step S91).

Specifically, the importance degree is calculated by an expression as follows:

$${I}_{k} = {\sum }_{j = 1}^{q} {α}_{k}^{′} \cdot {β}_{k} \cdot {f}_{jk} \qquad ( 5 )$$

The expression (5) represents a total value of values of terms for a feature k in the expression (3) for the q selected groups.

By carrying out such a processing, data as illustrated in FIG. 30 is stored in the fifth data storage unit 110. In an example of FIG. 30, the calculated importance degree iₖ is stored for each feature.

After that, the importance degree processing unit 109 determines whether or not there is an unprocessed feature (step S93). When there is an unprocessed feature, the processing returns to the step S89. On the other hand, when there is no unprocessed feature, the importance degree processing unit 109 sorts the feature in descending order of the importance degree, and stores the sorting result into the fifth data storage unit 110 (step S95). By this processing, it becomes possible to obtain the ranking data representing which feature is important. Then, the processing returns to the calling-source processing.

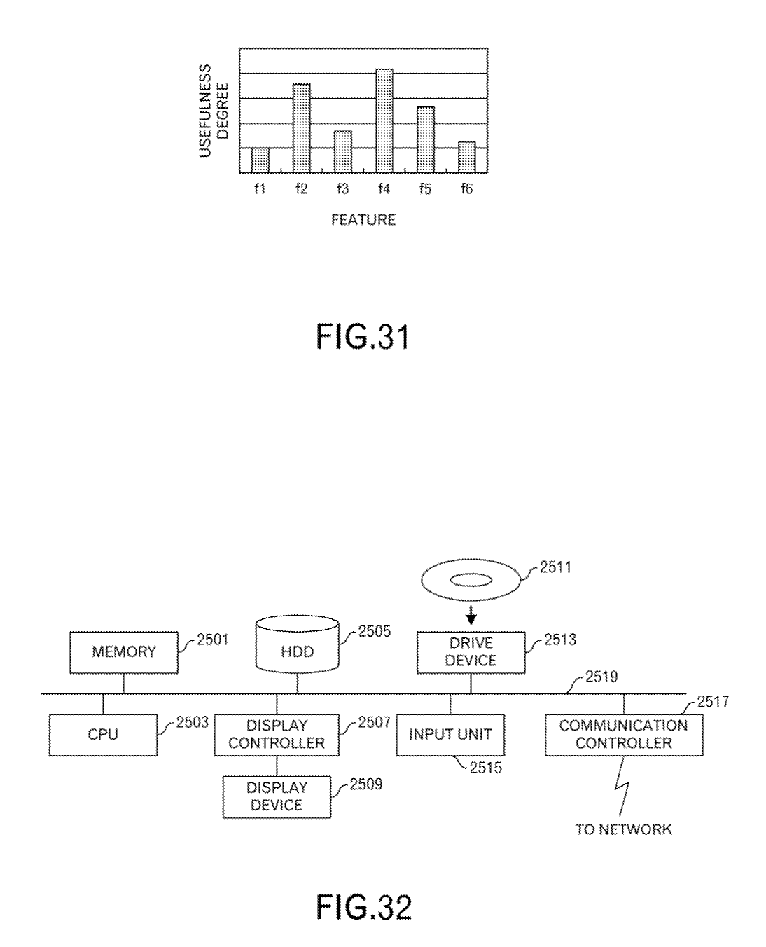

Returning to the explanation of the processing of FIG. 6, the output processing unit 111 carries out a data output processing to output to the output device 112, data requested, for example, from the user among data stored in the fifth data storage unit 110, fourth data storage unit 108, third data storage unit 106 and second data storage unit 105 (step S9). Data under the processing as illustrated in FIGS. 22A and 22B, data of the usefulness degree as illustrated in FIG. 31 (each of the case of the common circuit and the case of the common process or combination of them), data of the failure occurrence probability prediction expression as illustrated in FIG. 25, selection results of the failure occurrence probability prediction expression as illustrated in FIG. 26, data of the importance degree ranking as illustrated in FIG. 30 is outputted. Other calculation results may be outputted.

By carrying out the aforementioned processing, it is expected that the user having no knowledge concerning the failure factors can improve the accuracy of the failure factor presumption even in case that there is a little amount of the failure report data.

Although the embodiment of this technique is explained, this technique is not limited to the embodiment. For example, the functional block diagram of FIG. 1 is a mere example, and does not always correspond to an actual program module configuration. Furthermore, the data storage modes are mere examples, similarly.

Furthermore, as long as the processing results do not change, the order of the steps may be exchanged, and the steps may be executed in parallel. In addition, the processing may be omitted after data to be obtained is calculated.

FIG. 1 illustrates an example that one computer carries out the aforementioned processing. However, the processing may be executed by plural computers. Furthermore, the failure diagnosis support apparatus may be implemented by a client-server system.

Moreover, the expression to calculate the usefulness degree, the expression to calculate the goodness-of-fit index and other expressions may be transformed according to the objects.

In addition, the aforementioned failure diagnosis support apparatus 100 is a computer device as shown in FIG. 32. That is, a memory 2501 (storage device), a CPU 2503 (processor), a hard disk drive (HDD) 2505, a display controller 2507 connected to a display device 2509, a drive device 2513 for a removable disk 2511, an input device 2515, and a communication controller 2517 for connection with a network are connected through a bus 2519 as shown in FIG. 32. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform necessary operations. Besides, intermediate processing data is stored in the memory 2501, and if necessary, it is stored in the HDD 2505. In this embodiment of this technique, the application program to realize the aforementioned functions is stored in the computer-readable, non-transitory removable disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the necessary application programs systematically cooperate with each other, so that various functions as described above in details are realized.

The aforementioned embodiment is summarized as follows:

A failure diagnosis support method relating to the embodiment includes: (A) calculating a first expected value of the number of failures for each combination of a feature of a plurality of features that are failure factors and a first group of a plurality of first groups regarding classification elements of first semiconductor devices for which a failure is analyzed and second semiconductors on which a same circuit as the first semiconductors is implemented, from first data for each of the plurality of first groups and a predetermined expression, wherein the first data includes the number of actual failures occurred in the first group and first feature values of the plurality of features, and the first data is stored in a first data storage unit, and the calculated first expected value is stored in a second data storage unit; and (B) calculating, for each of the plurality of features, a first indicator value representing similarity between a distribution of the first expected values over the plurality of first groups and a distribution of the numbers of actual failures over the plurality of first groups, from the first expected value for each combination of the feature and the first group and the number of actual failures for each of the plurality of first groups, and storing the calculated first indicator value into a third data storage unit.

Even in a case where there is a little amount of data for the semiconductor device to be analyzed, data for other semiconductor devices having the same circuit as the semiconductor to be analyzed in addition to the semiconductor device to be analyzed is utilized to calculate the first indicator value (e.g. usefulness degree) that can be utilize for modifications of the design and manufacture. Moreover, the ranking of the features can be carried out by using the first indicator values. Furthermore, this is utilized for the generation of an appropriate failure occurrence probability expression. Incidentally, the classification element may be a circuit type.

In addition, the aforementioned method may further include: (C) calculating a second expected value of the number of failures for each combination of the feature and a second group of a plurality of second groups regarding classification elements of the first semiconductor devices and third semiconductors manufactured by using a same process as the first semiconductors, from second data for each of the plurality of second groups and the predetermined expression, wherein the second data includes the number of actual failures occurred in the second group and second feature values of the plurality of features, the second data is stored in the first data storage unit, and the second expected value is stored in the second data storage unit; and (D) calculating, for each of the plurality of features, a second indicator value representing similarity between a distribution of the second expected values over the plurality of second groups and a distribution of the numbers of actual failures over the plurality of second groups, from the second expected value for each combination of the feature and the second group and the number of actual failures for each of the plurality of second groups, and storing the second indicator value into the third data storage unit.

Thus, even in a case where there is a little amount of data for the semiconductor device to be analyzed, data for the semiconductor device manufactured by the same manufacturing process in addition to the semiconductor device to be analyzed is utilized to calculate the second indicator value (e.g. usefulness degree) that can be utilized for the modification of the design and/or manufacture. By using the second indicator value, the ranking of the feature can be carried out. Furthermore, the second indicator value may be utilized for the generation of an appropriate failure occurrence probability prediction expression. Incidentally, the classification element may be a position of a die on a wafer.

The aforementioned method may further include: (E) identifying first features for which the first indicator values satisfying a predetermined first condition are calculated; (F) calculating a first regression expression for calculating a failure occurrence probability using the plurality of features as variables, by carrying out a regression analysis for third data for each third group of a plurality of third groups regarding classification elements of the first semiconductors, after setting 1 to weights of the identified first features and setting a value less than 1 to weights of features other than the identified first features, wherein the third data includes the number of actual failures occurred in the third group and third feature values of the plurality of features, the third data is stored in the first data storage unit and the first regression expression is stored in a fourth data storage unit; (G) identifying second features for which the second indicator values satisfying a predetermined second condition are calculated; (H) calculating a second regression expression for calculating a failure occurrence probability using the plurality of features as variables, by carrying out a regression analysis for the third data, after setting 1 to weights of the identified second features and setting 0 to weights of features other than the identified second features, and storing the second regression expression into the fourth data storage unit; (I) calculating a third regression expression for calculating a failure occurrence probability using the plurality of features as variables, by carrying out a regression analysis for the third data, after setting 1 to weights of the plurality of features, and storing the third regression expression into the fourth data storage unit; and (J) identifying an regression expression whose goodness-of-fit index for the third data is the greatest from among the first regression expression, the second regression expression and the third regression expression.

Accordingly, an appropriate model expression for calculating the failure occurrence probability can be obtained. Namely, in order to prevent from the leakage of the features to be considered, the normal regression analysis is also carried out to evaluate the features by the goodness-of-fit index. In addition, the first indicator value and second indicator value are utilized to set appropriate weights for the features. Namely, when the first indicator value is not so good (e.g. the goodness-of-fit between the distributions is low), the term of the regression expression for such a feature is adopted but its weight value is lowered in order to lower the influence to the first regression expression. In addition, when the second indicator value is not so good, 0 is set to the weight values not to adopt the term of the regression expression for such a feature. Then, the influence of such a feature is excluded. This is because the similarity between the semiconductor device to be analyzed and the semiconductor devices having the same circuit is higher than that with the semiconductor devices manufactured by the same process. In addition, in this processing, the third data is used for the regression analysis. This is because the influence due to the bias or the like of the failure data used for calculating the first and second indicator values is suppressed.

Furthermore, the aforementioned method may further include: (K) calculating a prediction value of the failure occurrence probability for each of the plurality of third groups according to the identified regression expression; identifying a top N third groups in descending order of the prediction value, wherein the N is an integer; calculating, for each of the plurality of features, a total sum of values of a term of the feature in the identified regression expression by using data of the top N third groups; and (L) sorting the plurality of features in descending order of the calculated total sum. Thus, the ranking of the features can be obtained.

Incidentally, it is possible to create a program causing a computer to execute the aforementioned processing, and such a program is stored in a computer readable storage medium or storage device such as a flexible disk, CD-ROM, DVD-ROM, magneto-optic disk, a semiconductor memory, and hard disk. In addition, the intermediate processing result is temporarily stored in a storage device such as a main memory or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A computer-readable, non-transitory storage medium storing a program for causing a computer to execute a procedure comprising:
calculating a first expected value of the number of failures for each combination of a feature of a plurality of features that are failure factors and a first group of a plurality of first groups regarding classification elements of first semiconductor devices for which a failure is analyzed and second semiconductors on which a same circuit as the first semiconductors is implemented, from first data for each of the plurality of first groups and a predetermined expression, wherein the first data includes the number of actual failures occurred in the first group and first feature values of the plurality of features; and
calculating, for each of the plurality of features, a first indicator value representing similarity between a distribution of the first expected values over the plurality of first groups and a distribution of the numbers of actual failures over the plurality of first groups, from the first expected value for each combination of the feature and the first group and the number of actual failures for each of the plurality of first groups.

2. The computer-readable, non-transitory storage medium as set forth in claim 1, wherein the procedure further comprises:
calculating a second expected value of the number of failures for each combination of the feature and a second group of a plurality of second groups regarding classification elements of the first semiconductor devices and third semiconductors manufactured by using a same process as the first semiconductors, from second data for each of the plurality of second groups and the predetermined expression, wherein the second data includes the number of actual failures occurred in the second group and second feature values of the plurality of features; and
calculating, for each of the plurality of features, a second indicator value representing similarity between a distribution of the second expected values over the plurality of second groups and a distribution of the numbers of actual failures over the plurality of second groups, from the second expected value for each combination of the feature and the second group and the number of actual failures for each of the plurality of second groups.

3. The computer-readable, non-transitory storage medium as set forth in claim 2, wherein the procedure further comprises:
identifying first features for which the first indicator values satisfying a predetermined first condition are calculated;
calculating a first regression expression for calculating a failure occurrence probability using the plurality of features as variables, by carrying out a regression analysis for third data for each third group of a plurality of third groups regarding classification elements of the first semiconductors, after setting 1 to weights of the identified first features and setting a value less than 1 to weights of features other than the identified first features, wherein the third data includes the number of actual failures occurred in the third group and third feature values of the plurality of features;
identifying second features for which the second indicator values satisfying a predetermined second condition are calculated;
calculating a second regression expression for calculating a failure occurrence probability using the plurality of features as variables, by carrying out a regression analysis for the third data, after setting 1 to weights of the identified second features and setting 0 to weights of features other than the identified second features;
calculating a third regression expression for calculating a failure occurrence probability using the plurality of features as variables, by carrying out a regression analysis for the third data, after setting 1 to weights of the plurality of features; and
identifying an regression expression whose goodness-of-fit index for the third data is the greatest from among the first regression expression, the second regression expression and the third regression expression.

4. The computer-readable, non-transitory storage medium as set forth in claim 3, wherein the procedure further comprises:
calculating a prediction value of the failure occurrence probability for each of the plurality of third groups according to the identified regression expression;
identifying a top N third groups in descending order of the prediction value, wherein the N is an integer;
calculating, for each of the plurality of features, a total sum of values of a term of the feature in the identified regression expression by using data of the top N third groups; and
sorting the plurality of features in descending order of the calculated total sum.

5. A failure diagnosis support method comprising:
calculating, by using a computer, a first expected value of the number of failures for each combination of a feature of a plurality of features that are failure factors and a first group of a plurality of first groups regarding classification elements of first semiconductor devices for which a failure is analyzed and second semiconductors on which a same circuit as the first semiconductors is implemented, from first data for each of the plurality of first groups and a predetermined expression, wherein the first data includes the number of actual failures occurred in the first group and first feature values of the plurality of features; and
calculating, by using the computer, for each of the plurality of features, a first indicator value representing similarity between a distribution of the first expected values over the plurality of first groups and a distribution of the numbers of actual failures over the plurality of first groups, from the first expected value for each combination of the feature and the first group and the number of actual failures for each of the plurality of first groups.

6. The failure diagnosis support method as set forth in claim 5, further comprising:
calculating, by using the computer, a second expected value of the number of failures for each combination of the feature and a second group of a plurality of second groups regarding classification elements of the first semiconductor devices and third semiconductors manufactured by using a same process as the first semiconductors, from second data for each of the plurality of second groups and the predetermined expression, wherein the second data includes the number of actual failures occurred in the second group and second feature values of the plurality of features; and
calculating, by using the computer, for each of the plurality of features, a second indicator value representing similarity between a distribution of the second expected values over the plurality of second groups and a distribution of the numbers of actual failures over the plurality of second groups, from the second expected value for each combination of the feature and the second group and the number of actual failures for each of the plurality of second groups.

7. The failure diagnosis support method as set forth in claim 6, further comprising:
identifying, by using the computer, first features for which the first indicator values satisfying a predetermined first condition are calculated;
calculating, by using the computer, a first regression expression for calculating a failure occurrence probability using the plurality of features as variables, by carrying out a regression analysis for third data for each third group of a plurality of third groups regarding classification elements of the first semiconductors, after setting 1 to weights of the identified first features and setting a value less than 1 to weights of features other than the identified first features, wherein the third data includes the number of actual failures occurred in the third group and third feature values of the plurality of features;
identifying, by using the computer, second features for which the second indicator values satisfying a predetermined second condition are calculated;
calculating, by using the computer, a second regression expression for calculating a failure occurrence probability using the plurality of features as variables, by carrying out a regression analysis for the third data, after setting 1 to weights of the identified second features and setting 0 to weights of features other than the identified second features;
calculating, by using the computer, a third regression expression for calculating a failure occurrence probability using the plurality of features as variables, by carrying out a regression analysis for the third data, after setting 1 to weights of the plurality of features; and
identifying, by using the computer, an regression expression whose goodness-of-fit index for the third data is the greatest from among the first regression expression, the second regression expression and the third regression expression.

8. The failure diagnosis support method as set forth in claim 7, further comprising:
calculating, by using the computer, a prediction value of the failure occurrence probability for each of the plurality of third groups according to the identified regression expression;
identifying, by using the computer, a top N third groups in descending order of the prediction value, wherein the N is an integer;
calculating, by using the computer, for each of the plurality of features, a total sum of values of a term of the feature in the identified regression expression by using data of the top N third groups; and
sorting, by using the computer, the plurality of features in descending order of the calculated total sum.

9. A failure diagnosis support apparatus comprising:
a memory;
a processing unit using the memory and configured to execute a procedure:
calculating a first expected value of the number of failures for each combination of a feature of a plurality of features that are failure factors and a first group of a plurality of first groups regarding classification elements of first semiconductor devices for which a failure is analyzed and second semiconductors on which a same circuit as the first semiconductors is implemented, from first data for each of the plurality of first groups and a predetermined expression, wherein the first data includes the number of actual failures occurred in the first group and first feature values of the plurality of features; and
calculating, for each of the plurality of features, a first indicator value representing similarity between a distribution of the first expected values over the plurality of first groups and a distribution of the numbers of actual failures over the plurality of first groups, from the first expected value for each combination of the feature and the first group and the number of actual failures for each of the plurality of first groups.

10. The failure diagnosis support apparatus as set forth in claim 9, wherein the procedure further comprises:
calculating a second expected value of the number of failures for each combination of the feature and a second group of a plurality of second groups regarding classification elements of the first semiconductor devices and third semiconductors manufactured by using a same process as the first semiconductors, from second data for each of the plurality of second groups and the predetermined expression, wherein the second data includes the number of actual failures occurred in the second group and second feature values of the plurality of features; and
calculating, for each of the plurality of features, a second indicator value representing similarity between a distribution of the second expected values over the plurality of second groups and a distribution of the numbers of actual failures over the plurality of second groups, from the second expected value for each combination of the feature and the second group and the number of actual failures for each of the plurality of second groups.

11. The failure diagnosis support apparatus as set forth in claim 10, wherein the procedure further comprises:
identifying first features for which the first indicator values satisfying a predetermined first condition are calculated;
calculating a first regression expression for calculating a failure occurrence probability using the plurality of features as variables, by carrying out a regression analysis for third data for each third group of a plurality of third groups regarding classification elements of the first semiconductors, after setting 1 to weights of the identified first features and setting a value less than 1 to weights of features other than the identified first features, wherein the third data includes the number of actual failures occurred in the third group and third feature values of the plurality of features;
identifying second features for which the second indicator values satisfying a predetermined second condition are calculated;
calculating a second regression expression for calculating a failure occurrence probability using the plurality of features as variables, by carrying out a regression analysis for the third data, after setting 1 to weights of the identified second features and setting 0 to weights of features other than the identified second features;
calculating a third regression expression for calculating a failure occurrence probability using the plurality of features as variables, by carrying out a regression analysis for the third data, after setting 1 to weights of the plurality of features; and
identifying an regression expression whose goodness-of-fit index for the third data is the greatest from among the first regression expression, the second regression expression and the third regression expression.

12. The failure diagnosis support apparatus as set forth in claim 11, wherein the procedure further comprises:
calculating a prediction value of the failure occurrence probability for each of the plurality of third groups according to the identified regression expression;
identifying a top N third groups in descending order of the prediction value, wherein the N is an integer;
calculating, for each of the plurality of features, a total sum of values of a term of the feature in the identified regression expression by using data of the top N third groups; and
sorting the plurality of features in descending order of the calculated total sum.
